(19) United States
(12) Patent Application Publication
(10) Pub. No.: US 2011/0175780 A1
(43) Pub. Date: Jul. 21, 2011

(54) FLAT SCANNING ANTENNA

(75) Inventors: Roberto Vincenti Gatti, Perugia (IT); Luca Marcaccioli, Perugia (IT); Roberto Sorrentino, Perugia (IT)

(73) Assignee: RF MICROTECH S.r.l., PERUGIA (IT)

(21) Appl. No.: 12/736,962

(22) PCT Filed: May 28, 2009
(86) PCT No.: PCT/IT2009/000235

§ 371 Date: Apr. 5, 2011

(30) Foreign Application Priority Data
May 29, 2008 (IT) RM2008A000282

(51) Int. Cl. H01Q 13/18; H01Q 3/02

(52) U.S. Cl. 343/766; 343/771

(57) ABSTRACT

The present invention relates to a flat scanning antenna (1) comprising: a radiant unit (2; 2a), having a flat shape and comprising in its turn one or more radiant waveguides (7) arranged side by side as array, said radiant waveguides (7) being in their turn divided in one or more modules (9), on each of them there is one or more slots (6) arranged on the same plane to receive or transmit radio-frequency signals; and at least one beam forming network (8), connected to said radiant unit (2; 2a), to feed said modules (9) of said radiant waveguides (7) with proper phases, in order to realize the scanning of a radiant beam in elevation with respect said radiant unit (2; 2a).

The present invention relates to a flat scanning antenna.

More particularly, the invention relates to an antenna for satellite connection in reception and transmission, with customizable dimensions, suitable to be applied on terrestrial and aerial means of transport.

As it is well known, at present the antennas for the satellite connection are mostly “reflection” kind, i.e. parabolic dishes. This kind of antennas is generally very efficient and low cost, but they are also very cumbersome and so it's very difficult to install them on means of transport.

It's a now challenge the need to equip means of transport, terrestrial and aerial ones, such as trains, with a satellite connection broadband (internet, digital tv, etc.) without modifying the profile of the mean of transport, damaging the aesthetic and modifying the structure.

Moreover, in some cases, the use of the conventional parabolic antennas is not possible, for instance in the double-deck trains wherein the available space for the installation is really narrow, or even in the aircraft wherein the aerodynamic impact of a jutting antenna is not tolerable.

In light of the above, it is object of the invention to propose a flat antenna with customizable dimensions to be installed in moving means of transport.

It is therefore specific object of the present invention a flat scanning antenna comprising: a radiant unit, having a flat shape and comprising in its turn one or more radiant waveguides arranged side by side as array, said radiant waveguides being in their turn divided in one or more modules, on each of them there is one or more slots arranged on the same plane to receive or transmit radio-frequency signals; and at least one beam forming network, connected to said radiant unit, to feed said modules of said radiant waveguides with proper phases, in order to realize the scanning of a radiant beam in elevation with respect said radiant unit.

Always according to the invention, said antenna could comprise a recombination network for connecting said radiant waveguides and said beam forming network, suitable to combine or divide receiving or transmitting signals from/to said radiant unit with said proper phases, in order to realize the scanning of said radiant beam in elevation with respect said radiant unit.

Still according to the invention, said recombination network could comprise several waveguides arranged vertically.

Further according to the invention, the modules set as array of said one or more radiant waveguides could make a panel and said radiant unit comprises 2N panels, wherein N is a natural number and N≠0; and in that it comprises a N number of combination/division levels, so that as i is a variable from 1 to N:
the first level of combination/division, with i=1, has a set of waveguides for each couple of contiguous panels, the end of each waveguide being connected to a respective module of said couple of panels of said radiant unit;
each level of combination/division i-th, with i=2 . . . N, has a set of waveguides for each couple of waveguides set of the level combination/division (i−1)-th, whereas each end of each of said waveguides of the level combination/division i-th being connected sideways to a connection intermediate part of a respective waveguide of a waveguides set of the level combination/division (i−1)-th; and
the level of combination/division N-th has a set of waveguides each of them being connected, in its intermediate part, to said beam forming network.

Always according to the invention, one or more of said waveguides of the set of combination/division level N-th could have next to the connection to said beam forming network, a first iris.

Still according to the invention, one or more of said waveguides of the set of the combination/division level N-th comprise respectively a first post placed asymmetrically in the first iris and connected to said beam forming network.

Further according to the invention, one or more of said waveguides of the set of combination/division level N-th could be connected to said beam forming network through a respective opening.

Advantageously according to the invention, said waveguides could have on said connection intermediate part, a couple of second iris, suitable to remove the transmitted waves reflections.

Always according to the invention, said modules could have a connection hole and said waveguides of first combination/division level, with i=1, could have at their ends a third and a forth iris.

Still according to the invention, one or more of said waveguides of said set of first combination/division level, with i=1, could comprise respectively a second post, asymmetrically placed in said third iris, connected to a respective hole of one of said modules of a panel.

Further according to the invention, one or more of said waveguides of the set of first combination/division level, with i=1, could have respectively an opening for connecting with a respective module of a panel.

Advantageously according to the invention, said waveguides could have a rectangular section.

Always according to the invention, said waveguides could be put lower filled by air.

Still according to the invention, said waveguides could be in SIW (Substrate integrated Waveguide) or in stripline or realized on thick substrates or simple coaxial lines.

Further according to the invention, said beam forming network could comprise a first set of ports, for the input of the signals to be transmitted or for the output of the received signal, and a second set of ports, each of them connected to said radiant unit or to said recombination network.

Advantageously according to the invention, said beam forming network could be a Rotman lens or a Butler matrix or a Blass matrix or comprises phase shifters and/or is active or passive.

Always according to the invention, said radiant waveguides could be filled with a dielectric, they are metallic and they have a smaller dimension or the same dimension of a half wavelength λ₀ in free space.

Still according to the invention, said radiant waveguides could be single-ridge, they are metallic and they have a smaller dimension or the same dimension of half a wavelength λ₀ in free space.

Advantageously according to the invention, said slots could be simple and/or complex or multiple, and suitable to create linear, circular or elliptical polarizations.

Further according to the invention, said slots could be linear and/or crossed and/or as H shape, formed by more sections and/or being arbitrarily shaped.

Always according to the invention, said antenna could comprise flat base with an upper surface that can rotate around an axis that is perpendicular to said upper surface, wherein said radiant unit for the scanning of the beam in azimuth is placed; and motorized rotation means of said flat base.

The present invention will be now described for illustrative and non limitative purposes, according to its preferred embodiments, with particular reference to the figures of the enclosed drawings, wherein:

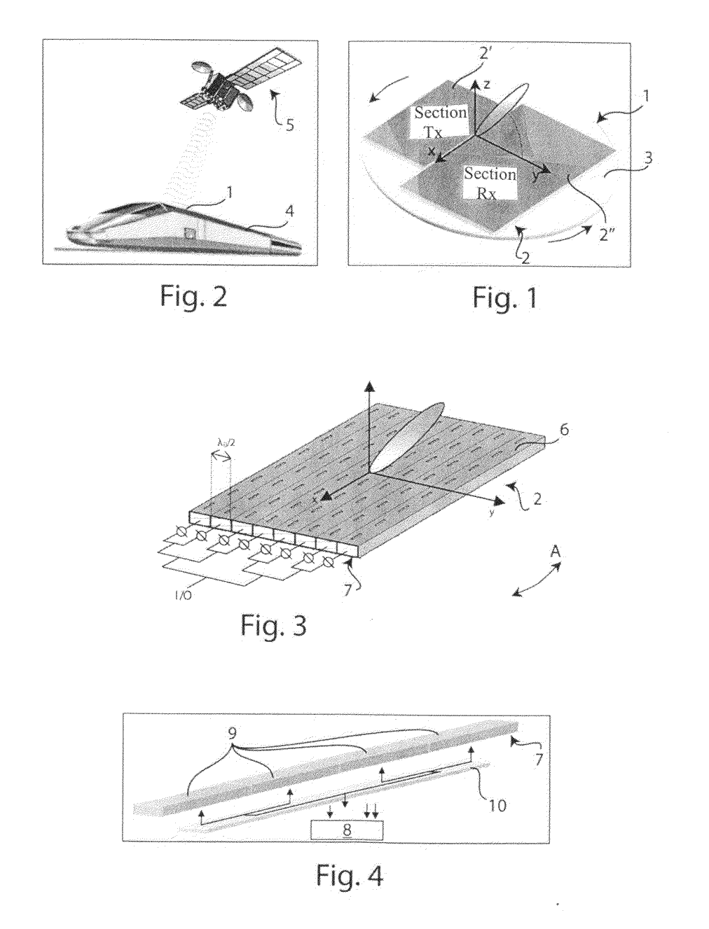

FIG. 1 shows a view of a flat scanning antenna according the present invention:

FIG. 2 shows an application of the antenna according to the FIG. 1;

FIG. 3 shows a perspective view of the radiant part of the antenna according to the FIG. 1;

FIG. 4 shows a radiant linear waveguide according to the FIG. 1;

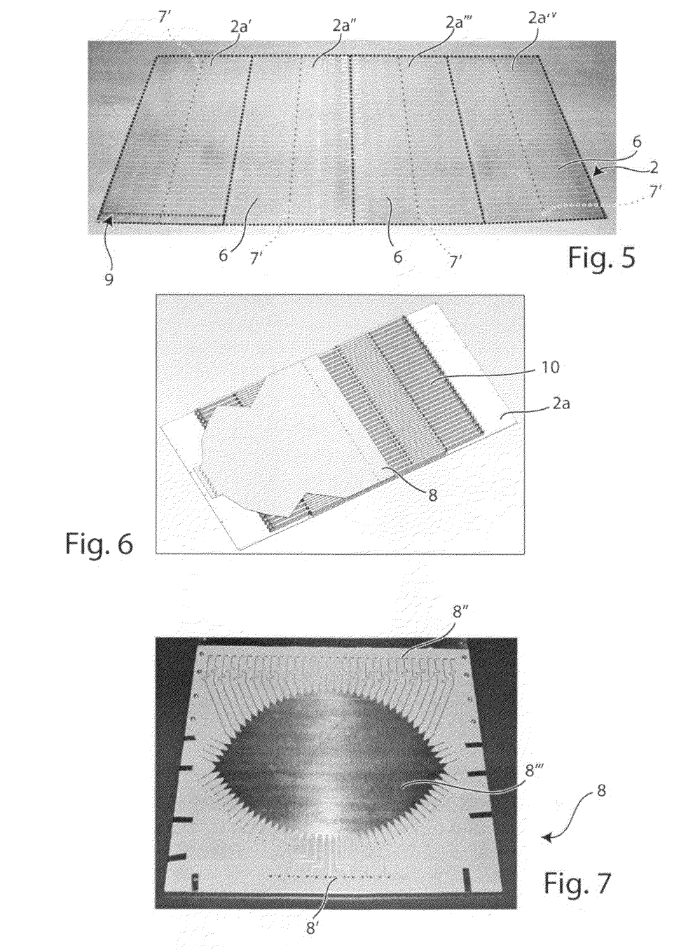

FIG. 5 shows a radiant unit divided into four modules of an embodiment of a flat scanning antenna according to the present invention;

FIG. 6 shows a rear perspective view of the antenna according to the FIG. 5;

FIG. 7 shows a perspective view of a beam forming network of the antenna according to the FIG. 5;

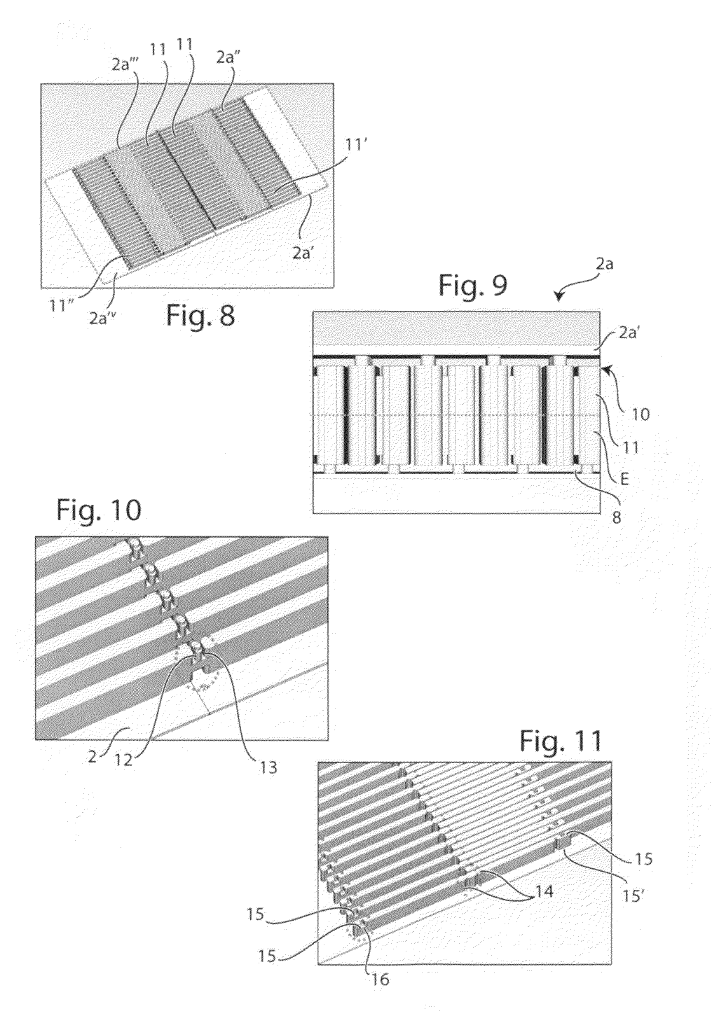

FIG. 8 shows a perspective view of the whole radiant unit and of a network of recombination of the antenna according to the FIG. 5;

FIG. 9 shows a lateral view of the antenna according to the FIG. 5;

FIG. 10 shows a transition from the recombination network and the beam forming network of the antenna according to FIG. 5;

FIG. 11 shows a transition between the recombination network and the radiant unit of the antenna according to FIG. 5;

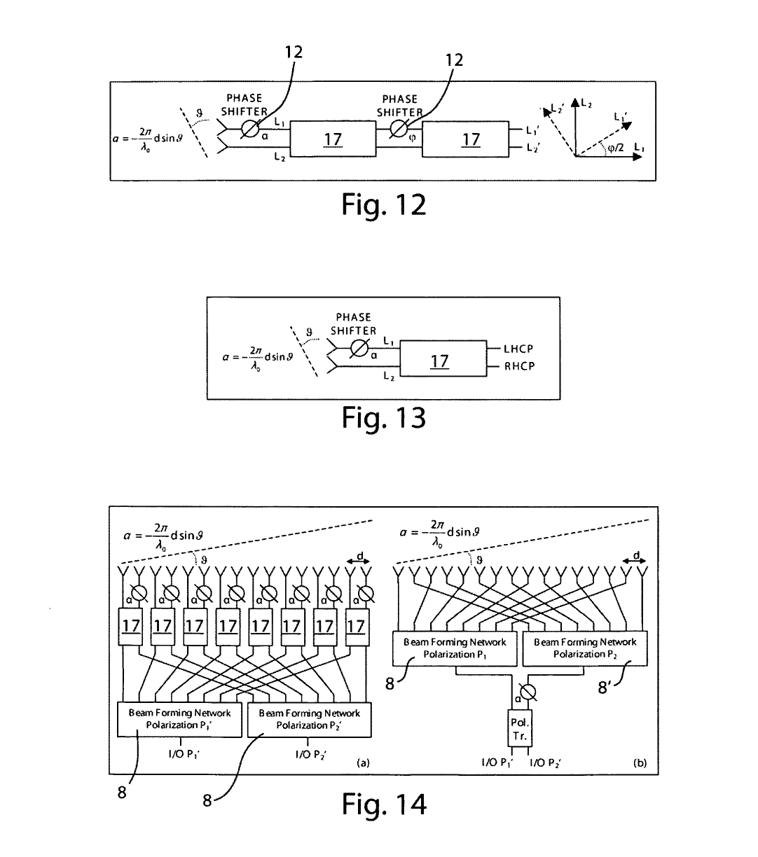

FIG. 12 shows a block diagram of a circuit for the combination of two linear polarizations;

FIG. 13 shows a block diagram of a circuit for the circular polarizations; and

FIG. 14 shows the block diagram of two circuits of polarization.

In the figures similar parts will be indicated with the same numerical references.

Making reference to FIG. 1 it's possible to see a schematic view of the flat scanning antenna 1 according to the invention.

Said antenna 1 comprises a radiant unit 2 with a first part 2′ of transmission and a second part 2″ of response. Said antenna 1 comprises also a support base 3 that can rotate around the z-axis as shown in the figures.

Said radiant unit 2 is flat thus allowing an installation of the same even on mobile means of transport, as illustrated in FIG. 2 where said antenna 1 is installed on the roof of a train 4 for the connection with the satellite 5.

FIG. 3 shows the radiant unit 2 of the antenna 1 that comprises an array of slots 6, eventually assembled in radiant waveguides 7 (sub-arrays). Said slots 6 allow the keeping of the flat outline of the radiant unit 2 of the antenna 1.

The slots 6, as can be seen, are practiced on metallic transmission lines that have a width minor or equal to half a wavelength λ₀ in free space (e.g. ridge guide, rectangular waveguides filled with dielectric, stripline etc.)

The slots 6 can be simple (single linear cut), complex (e.g. crossed, H type, etc.) or multiple, and so that to generate linear polarization, circular or elliptic.

Said slots 6 can be arbitrarily oriented, and they can be simple holes on the metal of the transmission line or made by more sections or they can have an arbitrary shape.

Said waveguides 7 are arranged side by side to set up a planar array and each of them is fed with the proper phase, in order to produce the scanning of the beam in elevation (z-y plane of the figure). The scanning of the beam in azimuth (x-y plane and see A arrow) is obtained by rotating in a mechanical way the antenna 1 around its vertical axis through the support base 3 through proper motorized means, not shown in the figures.

The scanning of the beam in elevation (y-z plane) takes place through proper beam forming network (BFN) that feed with signals having proper phase the different radiant waveguides 7 the antenna 1 is divided in.

The beam forming network is made by a network of multiple beams, wherein each input is associated to a different phase distribution on the several radiant waveguides 7 and as a consequence to a different beam. In this case, it's more generally said that it's a multi-beam beam forming network, even if later on we will use the expression beam forming network referring also to the multi-beam beam forming network.

This network can give rise to a scanning of the beam of discrete kind (switched beams) or continuous, through the use of a reconfigurable power dividing network connected to the inputs of the beam forming network itself.

The beam forming network is realized in printed circuit technology so as to guarantee a flat profile thus allowing the high compactness of the whole antenna 1. Said scanning network of the beam, moreover, can be active, that means it can foresee the presence of active components next to the ports connected to the radiant elements such as receiving Low Noise Amplifiers—LNA or transmitting Power Amplifiers—PA.

FIG. 4 shows the way each radiant waveguide 7 of said radiant unit 2 comprises several radiant modules 9, each of them has one or more slots 6. When the radiant waveguides 7 are close the one to the other, the array made by the modules 9 of the radiant waveguides 7 makes a panel.

In this case, in order to allow a feeding of the radiant waveguides 7, with all the radiant modules 9 with the proper phase to make the scanning in elevation, it's mandatory to integrate under each radiant waveguide 7 a proper recombination network 10, that allows to feed with the same phase all the radiant modules 9 and it's able to make division/combination operations of the signals to/from said beam forming network here indicated with the numerical reference 8.

In the particular case that the radiant modules 9 have different sizes, that means they have different number of slots, said recombination network 10 has to provide the proper power division as well.

The FIGS. 5-11 show an embodiment of a flat scanning antenna 1 according to the invention. Particularly, FIG. 5 shows the antenna 1, the radiant waveguides 7 of the radiant unit 2a make four panels 2aI, 2aII, 2aIII, e 2aIV, or sections, that are arranged side by side (each radiant waveguide 7 in this case comprises four modules 9) that present on the upper surface the slots 6.

Each panel 2aI, 2aII, 2aIII, e 2aIV comprises several joined modules 9 that have on the surface, besides the slots 6, a hole 7′ which function will be more detailed in the following.

FIG. 6 shows the structure of the antenna 1 seen on the back realized through the radiant unit 2a. Particularly, it's clearly distinguished the reciprocal disposition of the radiant unit 2a and of the beam forming network 8, it's put in the middle of them the recombination network 10 in rectangular waveguide. The signal coming from the beam forming network 8 is divided by the combination network 10 and transmitted with the proper phase to the radiant unit 2a allowing the scanning of the beam in elevation. As already said, for the scanning of the beam in azimuth the radiant unit 2a is properly rotated.

FIG. 7 is an embodiment of the beam forming network 8 that in this case is realized according to the technology of Rotman lens in microstrip.

As shown, said beam forming network 8 is on printed circuit and presents a flat shape. In any case, said beam forming network 8 can be of different kind 8, e.g. Rotman lens as in the case illustrated, but also Butler matrix, Blass matrix, it can comprise phase shifters (phased arrays), and/or be active or passive, etc.).

It's illustrated in the figure the series of ports 8′ and 8″, respectively input and output in case of transmission antenna, or output and input in case of receiving antenna. In the middle of the beam forming network 8 shown it's possible to see the “lens” indicated with the numerical reference 8′″ the electric field is spread by.

The recombination network 10 is arranged interposed between said radiant unit 2a and said printed circuit beam forming network 8.

Even in this case, it is necessary that said recombination network 10 has a reduced thickness in order to allow a plana configuration of the antenna. As well known, it implies considerable technological problems. In fact, in order to allow high performances, said recombination network 10 has to be made by low leakage transmission lines and allow, as said above, the division/recombination of the signals coming from the radiant modules 9 with lateral dimensions suitable for the housing of as many partitions as the radiant waveguides 7.

It can be considered, for example, technical solutions with flat profile as rectangular waveguides with reduced height, filled with air and set vertically, substrate integrated waveguide (SIW) or stripline, realized on thick substrate or simple coaxial lines.

Otherwise, if an active beam forming network 8 is employed, this can be replicated one for each radiation modules array 9 (i.e. for each panel 2a^{I}, 2a^{II}, 2a^{III} and 2a^{IV}) and the outgoing signals from the switches can be combined with a circuit (the recombination network 10) that can be also realized in printed technology.

The recombination network 10 in the illustrated embodiment rearranges the signals coming from the four radiant panels 2a′, 2a″, 2a′″ and 2a^{IV} of the radiant unit 2a, made each of them by radiant modules array 9.

The recombination takes place as the scheme illustrated in FIG. 8, where for each radiant waveguide 7 there is a controller ×4 that is as large as the radiant waveguide 7.

Referring to FIG. 9, the guides 11, which constitute the recombination network 10, are arranged, as can be seen, vertically with respect to one of the panels 2a′ of the radiant unit 2a and the beam forming network 8 (BFN), and the division takes place on the E-plane that is the plane wherein the transverse electric field of the fundamental mode lays, the TE10.

As already said, said guides 11 are connected between them sideways. This solution allows to maintain a very reduced vertical dimension of the antenna 1, equivalent to the thickness of a single guide 11.

The FIGS. 10 and 11 illustrate the transitions, i.e. the connection between the recombination network 10 with the beam forming network 8 and the radiant unit 2a. The transitions toward the radiant unit 2a and toward the beam forming network 8 are essential.

The recombination network 10 in rectangular waveguide 11 rearranges the signals coming from the four radiant panels 2a′, 2a″, 2a′″ and 2a^{IV} made by radiant modules array 9.

The recombination takes place as illustrated in the scheme in FIG. 4 and for each radiant waveguide 7 there is a combiner ×4 that is as large as the radiant waveguide 7. The waveguides 11 are set vertically with respect to the plane of the radiant unit 2a and of the beam forming network 8, and the division takes place on the E-plane, that, as already said, is the plane wherein the transverse electric field of the fundamental mode of the waveguide lays, the TE10.

With this solution it's possible to keep a very low profile, equivalent to the thickness of a single guide 11.

In other words, the figures show the vertical waveguides 11 divided in such a way as to see:
a first and a second set of guides 11′ and 11″ (first level of combination/division, i.e. connected to the radiant unit 2a), the ends of each of them are coupled to the holes 7′ of each module 9 of the panels 2a′and 2a″ and 2a′″ and 2a^{IV};
a third set of guides 11′″ (of second level of division, i.e. which signal in transmission is divided in the waveguide 11 of first level of division, and viceversa the signal received from said waveguide 11 of first level of division is re-combined), an end of each of them is coupled at the side to the central section of a guide of the said first set of guides 11′, while the central section is connected to said beam forming network 8.

The connection of the waveguides 11 to the holes 7′ will be more detailed in the following.

The transitions toward the radiant unit 2a and toward the multi-beam forming network 8 can be realized with slot coupling or direct coupling.

The last one is the preferable choice and it's realized with a metallic “post” (“post” has to be considered a conductor with a cylindrical shape that connects electrically two sections of a circuit).

The present embodiment of the invention illustrates the case of four panels, i.e. 2N, with N=2 equivalent to the number of combination/division levels the set of waveguides 11 have to be divided in. In case the panels are in even number but not a power of 2, e.g. six panels, then it's possible to realize an antenna through a couple of antennas, wherein the first antenna comprises four panels (2N, with N=2), and the second antenna comprises two panels (2N, with N=1), connected in an appropriate way through a beam forming network 8 for the distribution of the signal. In case of single panel antenna it's enough to connect the radiant guides 7 directly to the beam forming network 8.

In particular FIG. 10 illustrates the transition within the waveguides 11′″ of the recombination network 10 and the beam forming network 8. On the waveguide 11 it's set a first post 12 offset on a first iris 13 of the waveguide 11′″ itself and connected with the ports 8″ of the beam forming network 8.

FIG. 11, instead, illustrates the lateral coupling between the waveguide 11′ (or 11″) end of said first set and said rectangular waveguide 11′″, realized by two additional irises 14.

In the same figure it's also shown the coupling between the waveguide 11′ (or 11″) of first level of division and the panel 2a′ of the radiant unit 2a, realized by a third iris 15 wherein it's set a second post 16 put asymmetrically and a forth iris 15′.

Said post 16 is connected to a hole 7′ of a single module 9. The iris 14 and 15′ are to remove the reflections of the transmitted waves.

The transitions adopted in the realization illustrated in the FIGS. 10 and 11 are using both, as already said, metallic posts 12 and 16, connected to a waveguide 11, that are set asymmetrically respect to the H plane (plane wherein there the transverse magnetic field of the fundamental mode of the guide 11 lays). This configuration allows to create two loops that generate two magnetic fields of opposite side and different intensity, so that to produce a coupling with the magnetic field of the fundamental mode of the waveguide 11.

In case of the connection between the waveguides 11, in order to maximize the power transfer in the transition from/to the recombination network (depending on the fact that the antenna works receiving or transmitting), that means in order to have the best impedance matching between the interconnected transmission lines (printed circuit of the beam forming network 8—waveguide 11 or radiant module 9—waveguide 11) it's used the 15′ capacitive iris (reliefs on the inside part of the waveguide 11, realized on the large side that produce a local reduction in the guide 11 itself with the effect of a capacitive loading of the transmission line) put at the proper distance from the transition.

Capacitive iris 14 are also used in the junction that realizes the second level of division shown, as said, in FIG. 11, also in this case as elements for impedance matching. As shown, both the transitions are actually three ports networks and can be seen as power dividers/combiners.

In particular, the transition between the beam forming network 8 and recombination network 10 presents the port 8″ on printed circuit (line in micro stripe of the beam forming network 8) and two ports in waveguide (the signal goes from the beam forming network 8 to the recombination network 10 and is divided in the same parts on the two branches of the guides 11′ and 11″, or the two signals coming from the two branches in guide 11′ and 11″ are combined again on the microstrip port of the beam forming network 8).

Regarding the transition between the recombination network 10 and the radiant unit 2a, there is, instead, only one port in the recombination network 10 and two ports in the slotted transmission line that constitutes the radiant module: when the antenna 1 works in transmission the signal coming from the recombination network 10 is divided in the two sections of slotted line and is radiated in the free space through the slots 6: when, instead, the antenna 1 works in reception, the signal received by the single slots 6 is added on the two branches of the slotted line and is combined again through the transition on the port in guide 11′ or 11″ of the recombination network 11.

The complexity and the innovation of this kind of transitions is that the coupling with the waveguide 11 takes place on the narrow wall instead of on the large one as it usually happens.

The slots arrays 6 realized on the rectangular waveguides 7, or on the modules 9, when conventional waveguides (air-filled) are used, presents as known limited ability to scan the beam. To allow the propagation of the fundamental mode in the waveguides these one have to be larger than λ₀/2 (half a wavelength in free space). Including the thickness of the metallic lateral walls there is a distance between the radiant slots that is typically in the order of 0.6-0.8λ₀. This reduces the scanning angles range in which there is no occurrence of grating lobes, i.e. the lateral lobes remain below an acceptable level (typically <−10 dB). In particular, the lowest elevation that can be reached is equal to 65° and 75° respectively, values not always acceptable in certain application where elevations as low as 20° are required.

In order to reduce the cross dimensions, according to an embodiment of the invention, it's possible to use radiant waveguides 7 as single-ridge, or waveguides filled with a dielectric material with the proper dielectric constant, so as to make the distance between the radiant slots even smaller than half a wavelength in free space, thus removing the above mentioned problem of grating lobes. In particular, according to another embodiment, it's also possible to use radiant waveguides 7 realized by machining metallic elements or employing SIW (Substrate Integrated Waveguide) technology that is based on the realization of the guide on a dielectric substrate that has both sides plated and two rows of via-holes placed very close each other.

The radiant waveguides 7 considered in the embodiment described are made by a single conductor of rectangular section, or can be assumed to be a structure of such a kind (as for the rectangular guides realized in SIW technology). The fundamental mode for these transmission lines is the TE10 mode that produces superficial currents on the broad wall of the waveguide both in transverse and longitudinal direction. For this reason it's possible to excite an electric field on a slot on the broad wall of the guide, if it's in longitudinal direction and also if it's transverse or rotated around the guide axis of a certain angle.

Moreover, the radiant slots 6 can be also realized on a waveguide that is the radiant waveguide 7 supporting a TEM mode. This guide is made by two conductors not connected on to the other: an external conductor with the slot and an internal conductor suspended through proper supports or printed on a dielectric substrate put inside the external conductor.

Even in this case it's possible to realize the waveguide in SIW technology, laying one substrate upon the other and printing the internal conductor on the interface surface between the two substrates. Since the fundamental mode of this kind of waveguides is a TEM mode, on the surface of the external conductor only longitudinal currents will be generated. This kind of waveguides is able to excite only transverse or rotated slots, while the longitudinal ones are not excited.

In any case, it has to be considered that the described architectures are independent from the technological solutions used for the realization of waveguides that constitute the radiant waveguides 7, thus referring to them as generic TE or TEM structures, whatever it will be the fabrication technology used (metallic guides, SIW technology, printed technology, stripline . . . )

In an embodiment of the invention the waveguides that constitute the radiant waveguides 7 are filled with dielectric (or guides in SIW technology), so that the input impedance is modulated from the slots 6 offset with respect to waveguide centre line (line that longitudinally divides into two equal parts the broad wall of each radiant waveguide 7).

The amplitude distribution of the fields radiated by the slots 6 is fixed by an proper ratio between the offset, while the length of the slots 6 are set according to the operating frequency, as also the distance within the slots 6 along a radiant waveguide 7.

Regarding the polarization of the radiant unit 2, it's possible to have different configurations, for the cases wherein the antenna 1 has to work in single or double polarization, in circular or linear polarization with an arbitrary inclination.

In the simple case of linear polarization, vertical or horizontal, a single antenna 1 can be used, with slotted radiant unit 2, working with the proper polarization.

In case of working in double linear polarization or single linear polarization with an inclination angle of the electric field different from 0° or 90° two antennas 1 must be used, with slotted radiant waveguides 7 working in two polarizations. The input/output signals (depending on the case that the antenna 1 or the panel of the radiant unit 2 is transmitting/receiving) are combined in such a way as to produce the needed polarizations (polarization tracking). If the scanning angle is different from broadside, the signals coming from the two antennas 1 have to be properly phase-shifted.

FIG. 12 illustrates a scheme for the combination of the signals, with Li it's indicated the linear polarizations signals of the two antennas, while with d it's indicated the distance between the phase centers of the two antennas. The operations on the signals are obtained by the hybrid junctions 17 (3 dB coupler) and phase shifters 18 with phase shift angles α and φ.

Even in the case of double circular polarization (Left Hand Circular Polarization—LHCP and Right Hand Circular Polarization—RHCP) two antennas 1 must be used. If the scanning angle is different from broadside, the signals coming from the two antennas have to be accordingly phase-shifted. The scheme of the circuit to obtain the two circular polarizations from the input/output signals of the antennas is shown in FIG. 13. In this case a single hybrid junction 17 and a phase shifter 18 are required.

The two antennas working in the two different polarizations can be physically divided or they can share the same aperture. In this case the waveguides that constitute the slotted radiant waveguides 7 are interlaced.

The circuits that realize the polarization, shown in the FIGS. 12 and 13 can be connected each of them to the output of the two antennas like if they are physically divided or they can be replicated for each couple of slotted radiant waveguides 7, one belonging to the first antenna and the other belonging to the second.

In this last case, between the two radiant waveguides 7 it has to be introduced a difference of phase (that can be fixed or reconfigurable, depending on the specifications) related to the scanning angle in elevation.

The two possible solutions are shown in FIG. 14 where as illustrated in both cases two different beam forming networks 8 are employed.

In case of a bi-directional operation is required (receiving and transmitting) and the transmitting and receiving frequencies are too much different the one to the other, the structure of the single antenna is replicated scaling the dimensions so that to realize both the receiving and transmitting functions at the proper working frequencies.

An advantage of the present antenna according to the invention is that it can be used transmitting and receiving signals in Ku-band, so that the whole thickness of the antenna itself is less than 3 cm.

It should be appreciated that the above described methods and system can be changed in many ways.

Present invention has been described for illustrative and non limitative purposes with reference to preferred embodiments, but it is understood that variations and/or modifications can be introduced without departing from the relevant scope defined in the enclosed claims.

1. Flat scanning antenna (1) comprising: a radiant unit (2; 2a), having a flat shape and comprising in its turn one or more radiant waveguides (7) arranged side by side as array, said radiant waveguides (7) being in their turn divided in one or more modules (9), on each of them there is one or more slots (6) arranged on the same plane to receive or transmit radio-frequency signals; and at least one beam forming network (8), connected to said radiant unit (2; 2a), to feed said modules (9) of said radiant waveguides (7) with proper phases, in order to realize the scanning of a radiant beam in elevation with respect said radiant unit (2; 2a).

2. Antenna (1) according to the claim 1, characterized in that it comprises a recombination network (10) for connecting said radiant waveguides (7) and said beam forming network (8), suitable to combine or divide receiving or transmitting signals from/to said radiant unit (2; 2a) with said proper phases, in order to realize the scanning of said radiant beam in elevation with respect said radiant unit (2; 2a).

3. Antenna (1) according to the claim 2, characterized in that said recombination network (10) comprises several waveguides (11) arranged vertically.

4. Antenna (1) according to the claim 3, characterized in that the modules (9) set as array of said one or more radiant waveguides (7) make a panel (2a^{I}, 2a″, 2a′″ . . . ) and said radiant unit (2; 2a) comprises 2N panels (2a^{I}, 2a″, 2a′″ . . . ), wherein N is a natural number and N≠O; and in that it comprises a N number of combination/division levels, so that as i is a variable from 1 to N:
the first level of combination/division, with i=1, has a set of waveguides (11′, 11″) for each couple of contiguous panels, the end of each waveguide being connected to a respective module (9) of said couple of panels (2a^{I}, 2a″, 2a′″ . . . ) of said radiant unit (2; 2a);
each level of combination/division i-th, with i=2 . . . N, has a set of waveguides (11′″) for each couple of waveguides set of the level combination/division (i−1)-th, whereas each end of each of said waveguides of the level combination/division i-th being connected sideways to a connection intermediate part of a respective waveguide of a waveguides set of the level combination/division (i−1)-th; and
the level of combination/division N-th has a set of waveguides (11′″) each of them being connected, in its intermediate part, to said beam forming network (8).

5. Antenna (1) according to the claim 4, characterized in that one or more of said waveguides (11′″) of the set of combination/division level N-th has next to the connection to said beam forming network (8), a first iris (13).

6. Antenna (1) according to the claim 5, characterized in that one or more of said waveguides (11′″) of the set of the combination/division level N-th comprise respectively a first post (12) placed asymmetrically in the first iris (13) and connected to said beam forming network (8).

7. Antenna (1) according to claim 4, characterized in that one or more of said waveguides (11′″) of the set of combination/division level N-th are connected to said beam forming network (8) through a respective opening.

8. Antenna (1) according to claim 4, characterized in that said waveguides (11) have on said connection intermediate part, a couple of second iris (14), suitable to remove the transmitted waves reflections.

9. Antenna (1) according to claim 4, characterized in that said modules (9) have a connection hole (7′).

10. Antenna (1) according to claim 4, characterized in that said waveguides (11′, 11″) of first combination/division level, with i=1, has at their ends a third and a forth iris (15, 15′).

11. Antenna (1) according to the claim 10, characterized in that one or more of said waveguides (11′, 11″) of said set of first combination/division level (with i=1) comprise respectively a second post (16), asymmetrically placed in said third iris (15), connected to a respective hole (7^{I}) of one of said modules (9) of a panel (2a^{I}, 2a″, 2a′″ . . . ).

12. Antenna (1) according to claim 4, characterized in that one or more of said waveguides (11′, 11′″) of the set of first combination/division level (with i=1) have respectively an opening for connecting with a respective module (9) of a panel (2a^{I}, 2a″, 2a′″ . . . ).

13. Antenna (1) according to claim 3, characterized in that said waveguides (11) have a rectangular section.

14. Antenna (1) according to claim 3, characterized in that said waveguides (11) are put lower filled by air.

15. Antenna (1) according to claim 3, characterized in that said waveguides (11) are in SIW (Substrate integrated Waveguide) or in stripline or realized on thick substrates or simple coaxial lines.

16. Antenna (1) according to claim 1, characterized in that said beam forming network (8) comprises a first set of ports (8^{I}), for the input of the signals to be transmitted or for the output of the received signal, and a second set of ports (8″), each of them connected to said radiant unit (2; 2a) or to said recombination network (10).

17. Antenna (1) according to claim 1, characterized in that said beam forming network (8) is a Rotman lens or a Butler matrix or a Blass matrix or comprises phase shifters and/or is active or passive.

18. Antenna (1) according to claim 1, characterized in that said radiant waveguides (7) are filled with a dielectric, they are metallic and they have a smaller dimension or the same dimension of a half wavelength (A₀) in free space.

19. Antenna (1) according to claim 1, characterized in that said radiant waveguides (7) are single-ridge, they are metallic and they have a smaller dimension or the same dimension of half a wavelength (A₀) in free space.

20. Antenna (1) according to anyone of the preceding claims, characterized in that said slots (6) are simple and/or complex or multiple, and suitable to create linear, circular or elliptical polarizations.

21. Antenna (1) according to claim 1, characterized in that said slots (6) are linear and/or crossed and/or as H shape, formed by more sections and/or being arbitrarily shaped.

22. Antenna (1) according to claim 1, characterized in that it comprises a flat base (3) with an upper surface that can rotate around an axis (z) that is perpendicular to said upper surface, wherein said radiant unit (2: 2a) for the scanning of the beam in azimuth is placed; and motorized rotation means of said flat base (3).
